(19) United States
(12) Patent Application Publication
(10) Pub. No.: US 2012/0012677 A1
(43) Pub. Date: Jan. 19, 2012

(54) Spray gun handle support and quick release trigger assembly

(76) Inventor: L.T. Tom Crossley, III, Russellville, KY (US)

(21) Appl. No.: 12/804,675

(22) Filed: Jul. 16, 2010

(51) Int. Cl. B05B 15/06; B05B 9/01

(52) U.S. Cl. 239/526

(57) ABSTRACT

A spray gun handle support and quick release trigger assembly for use with a high pressure spray gun which includes an adapter for releaseable installation on a high pressure spray gun so that the trigger assembly holds the spray trigger in the on condition and the handle support provides an articulating brace adapter which is strapped to the user's arm and wrist to ease the stress of back pressure created by high pressure spray on the user's hand and wrist. The adapter utilizes two pivotally connected longitudinal members having at least one strap with hook and loop fasteners attached perpendicular to a first one of the longitudinal members for securing the brace to a forearm of the user. A spray gun handle support is pivotally attached to the distal end of a second one of the pivotal longitudinal members. The user holds the longitudinal members against the lower side of his forearm and fastens the hook and loop straps snugly around the forearm. The handle support body is inserted into and rotated within the spray gun handle and then the user grabs and holds the handle. In this position, the trigger is held on by the handle and the handle support body and brace provide support against the back pressure caused by the high pressure water spray.

### TECHNICAL FIELD

The present invention relates to the field of high pressure spray guns and in particular to devices intended to be used with a spray gun to relieve stress and stain on the wrist and hand of the user.

### BACKGROUND OF THE INVENTION

A power washer spray gun expels water at a high pressure for the purpose of cutting hard to remove dirt and debris from surfaces which are desired to be clean. The stream of water is at such a high pressure that accidental exposure to the stream could injure personnel or cause severe damage to soft surfaces. Therefore, it is absolutely necessary that a user maintains full and competent control of a spray gun. Because of the high pressure expulsion, a strong back pressure is produced against the hand and wrist of the spray gun user. After prolonged usage, a user will become tired or may suffer from muscle stress or strain due to the constant back pressure and the constant need to keep the trigger on the spray gun pressed. Eventually, the user may not have the strength to maintain the necessary control of the spray gun. This loss of control creates a dangerous situation for the user, those around him, and soft surfaces or parts which could be damaged or destroyed by a misdirected high pressure stream of water.

### DESCRIPTION OF THE RELATED ART

U.S. Pat. No. 6,079,639 by Barbato for HANDLE WITH LATCHING TRIGGER FOR POWER WASHER PRESSURE GUN issued on Jun. 27, 2000 teaches a two handle approach to easing the job of pressure washing and relieving stress on the wrist of a user. A first cylindrical handle attached perpendicular to the spray wand near the nozzle end provides control of the nozzle end. A second cylindrical handle combined with an additional trigger lever is attached to the conventional spray gun handle. Included with the second handle is a rigid wrist support with hook and loop strap for removably securing the user's wrist to the handle. Barbato requires permanent modification to the conventional handle and therefore does not provide for quick and easy installation. Barbato's locking trigger mechanism contains springs and other moving parts which may tend to jam. Further, Barbato hook and loop wrist support allows for limited flexing of a user's wrist but the user's wrist still must maintain angular control of the spray wand and therefore, the wrist and hand are still under a large strain.

U.S. Pat. No. 6,324,728 B1 by Blankenheim for ERGONOMIC ATTACHMENT FOR INLINE POWER TOOLS issued on Dec. 4, 2001 teaches a device intended to be easily and removably attached to a power tool such as a hand drill to ease stress and stain on a user's wrist. Blankenheim provides a padded U-shaped brace to be connected to the power tool and which is held down against the user's forearm by a spring so that the user's forearm bears some of the force applied to the power tool rather than applying all of the force to the user's wrist. However, Blankenheim does not relieve thrust force pushing back against a user's wrist, but only reduces vertical forces against the wrist. Blankenheim does not provide for easy operation of the trigger mechanism on a spray gun. Further, the installation of Blankenheim's device is not quick and easy.

### SUMMARY OF THE INVENTION

In accordance with the present invention, there is provided an handle for a high pressure spray gun comprising, consisting of or consisting essentially of a first longitudinal arm support member pivotally connected to a second longitudinal wrist support member and a spray gun handle-and-trigger support body pivotally connected to the second longitudinal member. The first longitudinal member pivotally has attached at a proximal end at least one strap with fasteners for temporarily attaching the first longitudinal member to a user's forearm. The second longitudinal member is pivotally connected at a distal end to the spray gun handle-and-trigger support body at one of two free ends of a first proximal yoke portion of the trigger support body. The spray gun handle-and-trigger support body includes a third longitudinal member having a cavity containing a plunger and spring. The spring urges the plunger out of a proximal end of the cavity and the plunger has a transverse bore in a distal end and a shoulder near the proximal end. The plunger is held captive within the cavity by a pin protruding from the transverse bore. The third longitudinal member has the first proximal yoke member permanently attached at a proximal end and a second yoke at a distal end. The open ends of both yokes face away from one another and the proximal end of the plunger protrudes from the center of the first proximal yoke.

It is an object of this invention to provide an high pressure spray gun handle which relieves the stress and strain on a user's wrist and hand.

It is an object of this invention to provide an high pressure spray gun handle which can be quickly, easily and removably installed on a conventional high pressure spray gun.

It is an object of this invention to provide an high pressure spray gun handle which is simple and easy to use.

It is an object of this invention to provide an high pressure spray gun handle which allows the user to pivot his wrist while transferring the majority of the back pressure from the spray gun to the user's fore arm.

It is an object of this invention to provide an high pressure spray gun handle which is easily and quickly removable so that a user may temporarily switch to normal handling of the spray gun without using the handle when desired or needed, for instance when working in close quarters.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a perspective view of a conventional high pressure spray gun.

FIG. 2 is a top view of an handle for high pressure spray gun.

FIG. 3 is a perspective view showing the first step to installing the handle onto a conventional spray gun.

FIG. 4 is a perspective view showing the handle installed on a conventional spray gun.

FIG. 5 is a perspective view showing a handle installed on a conventional spray gun held in place on a user's arm utilizing a loop type of trigger guard.

FIG. 6 is a perspective view showing a handle having a trigger guard extending only across the front of the trigger.

### DESCRIPTION OF THE PREFERRED EMBODIMENTS

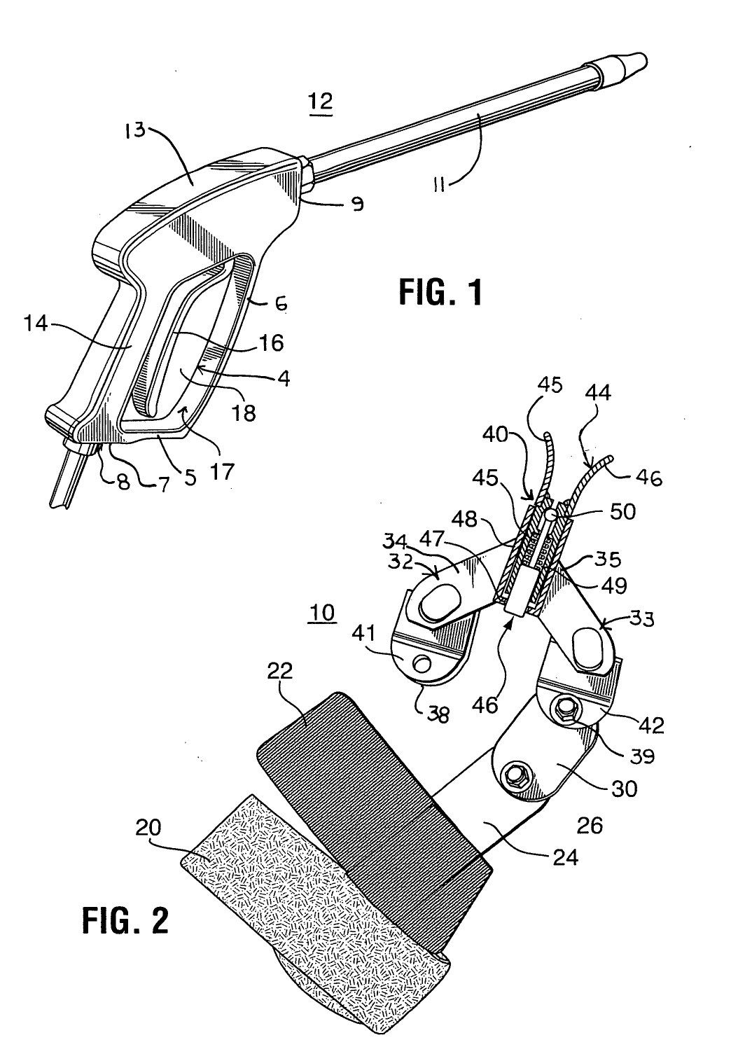

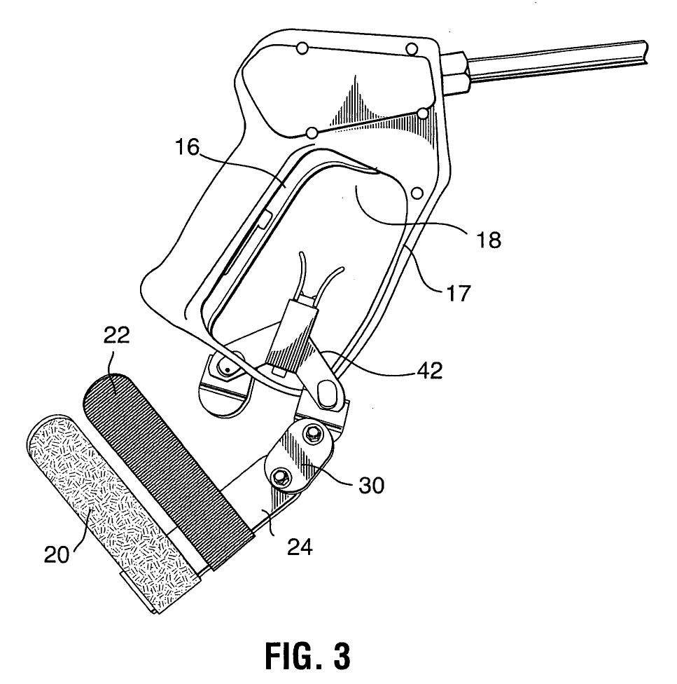

In accordance with FIGS. 1-5, the spray gun handle support and quick release trigger assembly 10 of the present invention, provides means to ease the use of a conventional spray gun by reducing stress and strain on the hand and wrist of a user.

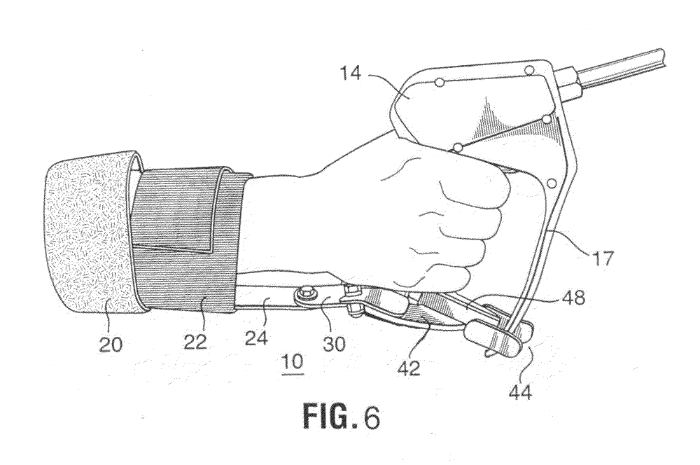

As shown in FIG. 1, a conventional spray gun 12 is shown having a generally tubular housing 13 including a conduit for carrying a liquid therethrough (not shown), and a rear handle 14 portion angled downwardly therefrom. The spray gun 12 includes a tubular member 11 having a nozzle (not shown) extending from the front end 9 of the housing 13. The bottom end 7 of the handle portion 14 of the housing 13 includes an adapter means 8 for connecting a water line or hose such as a threaded nipple or HANSEN fitting connection. As illustrated in FIGS. 1, 3-5, the trigger guard 17 includes a front elongated portion 6 extending downward at an angle from the bottom front portion of the housing 13 and a bottom elongated portion 5 extending inwardly toward a bottom front portion of the handle 14 forming a generally rectangular loop 4 having a distal end intersecting with the bottom of the handle 14. FIG. 6 shows an example of a trigger guard which functions with the adapter of the present invention without the elongated portion 5 forming the bottom of the loop.

In one preferred embodiment the housing, the handle, and the trigger guard are integrally formed from plastic, metal, or combinations thereof. A spring loaded trigger 15 pivotally attached to a valve in the housing and in fluid communication with the conduit carry the liquid there through extends downwardly a selected distance disposed within loop 4 for reciprocal movement therein. The spray gun handle requires the user to apply continuos manual force to hold squeeze the trigger in the “on” position to engage the actuator or valve in the housing allowing the fluid to flow therethrough. Holding the trigger for extended period of time causes fatigue in the fingers and hand of the operator.

The spray gun handle support and quick release trigger assembly 10 contains components composed of metal, plastic, fiberglass or combinations thereof. The assembly 10 includes a first longitudinal member arm support member 24 defining a longitudinal strip material. The first longitudinal member 24 has connected at a proximal end two straps 20 and 22 with hook and loop fasteners to be wrapped around the forearm of a user to provide support against back pressure created by an operating spray gun. The arm support member 24 is pivotally connected to a second shorter longitudinal member 30 by a pin, bolt, rivet, or other fastening means 26 enabling the member 30 to pivot laterally allowing for side to side wrist movement while still supporting the adapter assembly 10.

Pivotally attaching to the distal end of the second longitudinal member 30 opposite the arm support member 24 is the adapter for the handle and trigger support adapter body 40. The adapter 40 is pivotally connected to second longitudinal member 30 by a pin, rivet, bolt, or other fastening means 28 permitting lateral movement there between. Pins 26 and 28 comprise a bolt or screw with a nut, a smooth pin with a shoulder or head at on end and a transverse aperture at the other end to receive a cotter key to hold the pin in place, or any other form of pin which forms a pivot point or pivoting means for the two longitudinal members and the spray gun handle support body.

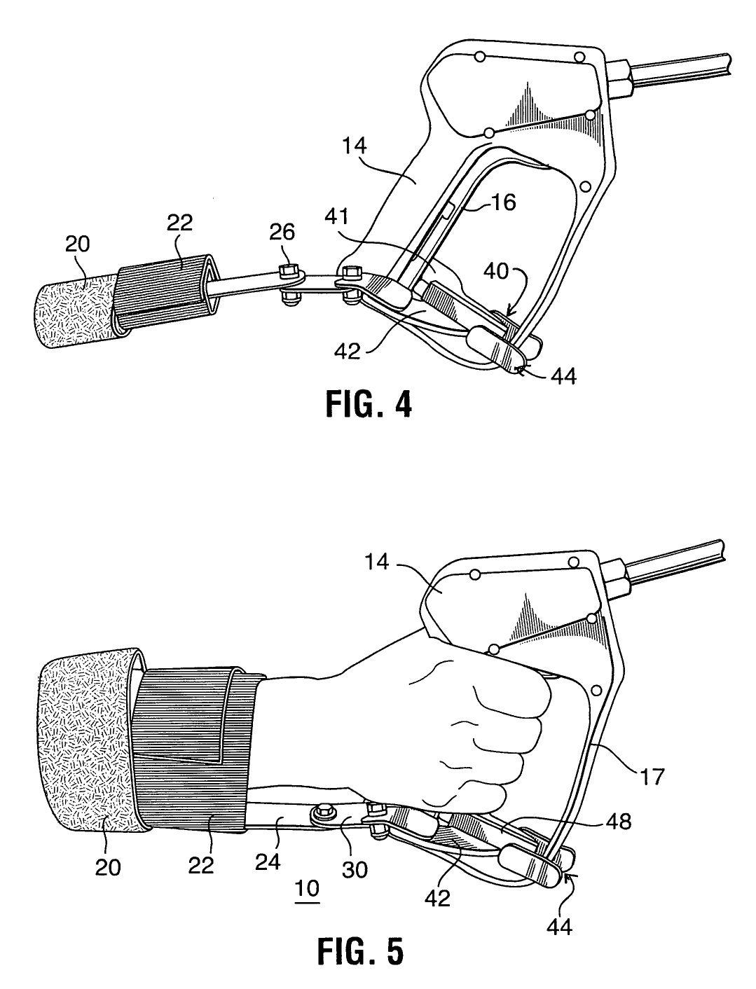

The adapter 10 includes a pair of flanges 32, 33, extending from the sides of the main body 40. As shown in a preferred embodiment, the flanges 32, 33 define short longitudinal members extending at a selected angle obtuse angle from the main body 40 forming a “V” shaped pattern having a distal end angled further backward parallel to the axis of the main body to space the arm support members away from the main body 40 of the adapter yet still maintain alignment therewith. Each one of the flanges 32, 33, include a proximate portion 34, 35 adjacent the main body extending laterally therefrom. The distal end of the flanges 32, 33 include a portion 41, 42, which are bent downward at a select angle with respect to the main body proximate portion 34, 35 and main body 40 and have distal ends 38, 39 pivotally attachable to either the distal end of the second longitudinal member 30 for lateral movement. Only one of the end portions 41 or 42 is connected to the second longitudinal member 30 depending upon whether the user is left handed or right handed in order for the handle of the sprayer to be swivelled laterally from side to side. As best shown in FIGS. 4 and 5 the angle of the bend between the distal end for the flanges 32, 33 and the portion connecting to the second longitudinal member 30 is less than 45 degrees, and more preferably less than 35 degrees, and more preferably between 3 to 30 degrees, and most preferably between 20 and 20 degrees from the horizontal axis of the second longitudinal member 30 to provide a comfortable yet supporting position for the wrist of the user. While not essential to the adapter and operation of the trigger mechanism the angled portion of the adapter is a significant ergonomical improvement over conventional trigger adjustment mechanisms and allows the user to operate the sprayer handle for extended periods of time with less arm fatigue.

The adapter 40 includes a longitudinal member 48 defining a main body having hollow cylinder or sleeve containing a plugger mechanism. A plunger 46 within the sleeve 48 is under pressure exerted by internal spring 45 and is thus urged out of a cavity 49 and through an aperture 47 at the proximal end of member 48. Retaining pin 50 protruding from a transverse bore at the distal end of plunger 46 prevents plunger 46 from being totally expelled from member 48. A spaced apart aligned pair of projections 45, 46 defining blades or tabs curve outwardly from the distal end of member 48 forming a yoke 44 for slidably engaging the front elongate portion 6 of the trigger guard 17 where it is held in position by a friction fit when the distal end of the member 48 abuts the interior surface of the trigger guard 17 and the spring loaded plugger 46 abuts the opposing interior surface of the handle 14.

FIGS. 2 and 4 show that when trigger support 40 is installed in conventional spray gun 12, with the proximal end of the spring loaded plunger 46 pressing against the spring loaded trigger 16 providing a liquid fluid channel in the handle with the main body 48 abutting the trigger guard 17 wherein the pressure holds the adapter and trigger device in the engaged “on” position as long as the plunger and yoke are in alignment normal to the handle and trigger guard. The “quick-release” feature is actuated by merely moving the plunger or the yoke upward removing the biasing pressure exerted by alignment of the plunger and yoke with respect to the handle and guard to releaseably disengage the spray trigger.

As shown in FIG. 5, the user's forearm is snugly strapped to handle 10 and the user's hand firmly grasps conventional handle 14. Hook and loop straps 20 and 22 help support handle 10 against the back pressure caused by the high pressure water stream emitting from the spray gun so that the user's hand and wrist don't have the full amount of back pressure applied directly to them. When trigger holder 40 is positioned in the spray gun, the trigger 16 is constantly being pressed and therefore, the gun is spraying. If the user should wish to stop spraying, he simply holds the top of the spray gun with his free hand, rotates the trigger holder 40 within cavity handle 18 to release the trigger and then withdraws holder 40 from the spray gun handle cavity 18. In situations where the user wishes to use the sprayer without the handle, he may now, simply grab the handle 14 of the spray gun 12 and use the sprayer 12 as normal. This may be desired where a user is spraying in a crowded area and want's more flexibility in a limited space. To resume spraying with the handle, the user simply re-inserts holder 40 into cavity 18, rotates holder 40 to press trigger 16 and then inserts his fingers into cavity 18 to grab handle 14 and resume spraying.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. An handle for a high pressure spray gun comprising:
a first longitudinal member pivotally connected to a second longitudinal member, said first longitudinal member having attached at a proximal end thereto at least one strap with fasteners for temporarily attaching said first longitudinal member to a user's forearm,
said second longitudinal member being pivotally connected at a distal end to a spray gun handle-and-trigger support body at one of two free ends of a first proximal yoke portion of said trigger support body,
said spray gun handle-and-trigger support body including a third longitudinal member having a cavity formed therein containing a plunger and spring, said spring urging said plunger out of a proximal end of said cavity and said plunger having formed therein a transverse bore in a distal end thereof and a shoulder near the proximal end thereof, said plunger being held captive within said cavity by a pin protruding from said transverse bore, said third longitudinal member having permanently attached thereto said first proximal yoke member at a proximal end and a second yoke at a distal end, the open ends of both yokes facing away from one another, the proximal end of said plunger protruding from the center of said first proximal yoke.

2. The device defined in claim 1 wherein said fasteners for said strap for temporarily attaching said first longitudinal member to a user's forearm comprise hook and loop fasteners.

3. The device defined in claim 1 wherein said fasteners for said strap for temporarily attaching said first longitudinal member to a user's forearm comprise a belt buckle.

4. The device defined in claim 1 wherein said pivot points for said pivoting first and said second longitudinal members and said spray gun handle-and-trigger comprise bolts and nuts.

5. The device defined in claim 1 wherein said pivot point for said pivoting first and said second longitudinal members and said spray gun handle-and-trigger comprise smooth pin and cotter key combinations.
